(19) United States
(12) Patent Application Publication
(10) Pub. No.: US 2006/0142119 A1
(43) Pub. Date: Jun. 29, 2006

(54) Drive mechanism

(76) Inventor: Christian Meixner, Ingolstadt (DE)

Correspondence Address: Peter N Lalos;Stevens Davis Miller & Mosher, 1615 L Street N W, Suite 850, Washington, DC, 20036, US

(21) Appl. No.: 10/544,712

(22) PCT Filed: Nov. 28, 2003
(86) PCT No.: PCT/EP03/13449

§ 371 Date: Aug. 5, 2005

(30) Foreign Application Priority Data
Feb. 6, 2003 (DE) 103 04 813.8

(51) Int. Cl. B60W 10/02

(52) U.S. Cl. 477/176

(57) ABSTRACT

The invention relates to a drive mechanism for all-wheel drive vehicles, comprising a variable-speed transmission and an interaxle differential for distributing drive torque onto a first and a second axle differential via which the front wheels and rear wheels of the motor vehicle are driven. A drive shaft of the variable-speed transmission drives a driving element of the interaxle differential while output elements of the interaxle differential are connected in a driving manner to the axle differentials. Also provided is a clutch which influences the output torque distribution. An infinitely 304 variable output torque distribution has the following characteristics:—the output gear ratios between the first and the second axle differential are different;—the configuration of the interaxle differential (16) is such that different output torques are provided to the axle differentials, the higher output torque being applied to the axle differential that has the shorter gear ratio;—a slip-controlled multi-disk clutch (46) is mounted between the driving element (32) of the interaxle differential and the output element (36) having the lower output torque; and—the multi-disk clutch (46) can be controlled according to operating parameters of the motor vehicle in order to variably distribute the output torques of the interaxle differential.

The invention relates to a drive mechanism for all-wheel-drive vehicles as specified in the preamble of claim 1.

All-wheel drives have been disclosed in a plurality of embodiments, such as permanent all-wheel drive, emergency all-wheel drive, one which may be engaged by way of a Visko clutch (shear friction clutch) or one with drive torque distribution by means of one or more electrohyaraulically controllable disk clutches. If drive torque distribution is to be effected in such all-wheel drives it is found to be relatively complicated and the control engineering to be costly. In addition, they are not continuously variable, for example, reversibility from rear loading (increased drive torque applied to the rear axle) by way of neutral to front loading cannot be achieved cost-effectively.

The object of the invention is to propose a generic drive mechanism which permits continuously variable distribution of drive torque to the front and rear wheels of the vehicle at relatively low structural and control engineering cost.

It is claimed for the invention that this object is attained by the characteristic features specified in claim 1. Advantageous developments of the process claimed for the invention are described in the additional claims.

Attainment of the object assigned is based on the following characteristics:

the output transmission ratios between the first and the second and axle differential differ;

the configuration of the interaxle differential is such that different drive torques to the axle differentials are present, the higher torque being applied to the shorter transmission axle differential;

a slip-controlled disk clutch is engaged between the drive element of the interaxle differential and the output element; and

the disk clutch may be controlled as a function of operating parameters of the vehicle in relation to the variable distribution of the drive torque values of the interaxle differential.

As a result of the characteristics described in the foregoing, by use of only one slip-controlled clutch the output torque may be reversed by continuous variation from the interaxle differential to the axle differentials (=drive torque of the axles) on the basis of the structurally determined basic distribution (e.g. 70:30) into neutral (50:50) and to a reverse load distribution (e.g., 30:70 or more). It is essential in this process that, in addition to the basic distribution of the interaxle differential structurally determined by the different transmission ratios of the axle differentials, the drive shafts leading to the respective axle differential have different speeds. Consequently, the basic distribution is varied rapidly by simple control engineering means in the direction of neutral, as is the reverse basic distribution, by increasing transmission of output torque by way of the slip-controlled disk clutch to the driven shaft, which always rotates at a lower speed. This control is effected as a function of the operation parameters of the vehicle such as speed, roadway conditions, ascending or descending gradients, gear change state, etc.

It is also proposed that by preference the shorter output transmission be effected at the axle differential driving the rear wheels of the vehicle and that the higher output torque of the interaxle differential be switched to this axle differential. A rear-heavy basic distribution is thereby created, one which may afford advantages with respect to vehicle dynamics in the case of sports-configured vehicles and which may undergo variable modification at any time when required.

The interaxle differential may be a conical gear differential configured to be asymmetric or, by preference, a more rugged planetary gear which is easier to control with respect to output torque distribution.

A design which is structurally especially compact and which, with respect to combination with a conventional all-wheel drive vehicle, represents problem-free amplification to a variable-control all-wheel drive, is characterized in that the output shaft of the gear change box drive-connected to the driving element of the interaxle differential of the gear change box is a hollow shaft on the end of which facing the driving element the disk clutch is mounted, which clutch may be engaged by the output shaft of the interaxle differential conducted back through the hollow shaft. The result is a sort of cartridge design which, on the basis of a conventional gear change box of a vehicle with integrated front-axle differential and an interaxle differential, permits production of an all-wheel drive with continuously variable drive torque distribution exclusively by replacement of the modified interaxle differential with an integrated slip-controlled disk clutch.

In addition, by preference the outer wheel of the epicyclic gear with higher output torque is drive-connected to the shorter geared axle differential for driving the rear wheels of the vehicle, as a result of which an especially favorable output torque distribution within the interaxle differential is provided, along with structurally simple configuration and mounting of the respective epicyclic gear.

As an alternative, the epicyclic gear may be a double epicyclic gear the radially inner planet wheels of which mesh with the sun wheel and its outlying planet wheels with the external gear. In addition, the external gear forms the drive element and for the sake of a shorter geared axle differential is represented by the planet wheel carrier bearing the two planet wheel sets. An even more greatly differentiating basic distribution of the output torque may thus be effected at relatively slight additional cost. This basic distribution advantageously extends the overall adjustability of the all-wheel drive for even better adaptation to the driving-dynamics requirements of the vehicle.

If suitable control engineering measures are applied, for example, by way of an electronic control mechanism and electrohydraulic control of the disk clutch, the latter may be slip-controlled as a function of the operation parameters and/or the driving dynamics parameters in such a way that the output torque of the interaxle differential may be adjusted continuously from the design-determined output torque distribution with priority to one axle differential by way of a neutral distribution to output torque distribution with priority to the other axle differential.

In the process the operation parameters may be by preference several electronically stored driving programs of an automatic speed change gear of the vehicle preselection of which determines different output torque distributions of the interaxle differential by appropriate actuation of the disk clutch. For example, in the case of a winter program more output torque is always directed to the front wheels of the vehicle and in that of a sports-car program more output torque is directed to the rear wheels.

In addition, driving dynamics parameters modified to particular advantage may be stored in an electronic driving stability program of the vehicle and, in addition to the conventional operations such as brake operation and output torque reduction of the driving machine, the output torque distribution of the interaxle differential may be modified in the direction of neutral and beyond by appropriate additional actuation of the disk clutch.

An exemplary embodiment of the invention is described in greater detail in what follows with reference to the drawing in diagram form, in which

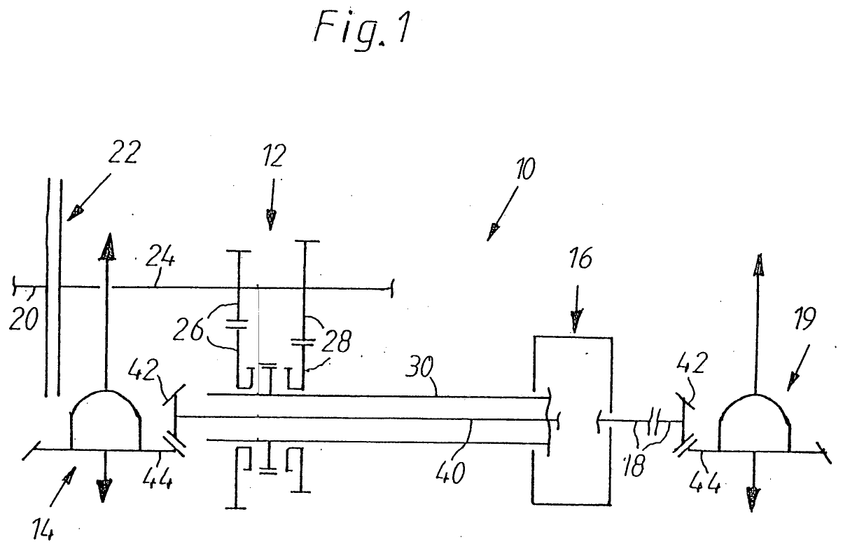

FIG. 1 presents a block diagram of a drive mechanism for an all-wheel-drive vehicle with a gear-change box with integrated front axle differential, an interaxle differential, and a rear axle differential;

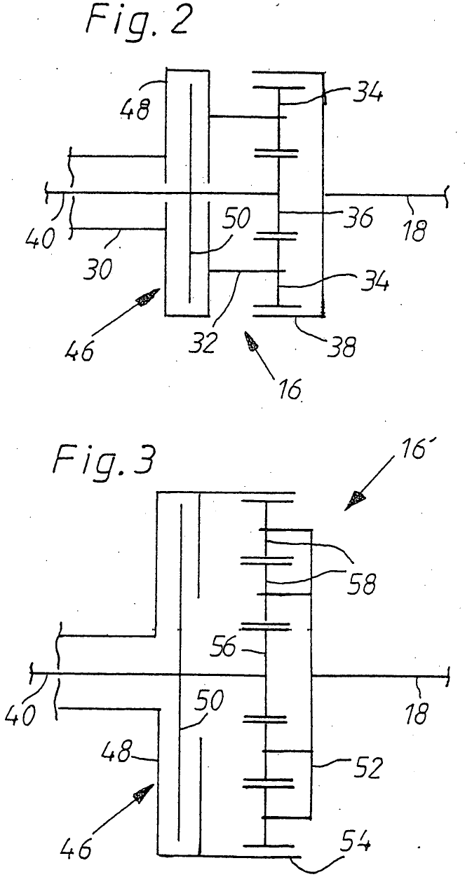

FIG. 2 the interaxle differential shown in FIG. 1 with slip-controlled disk clutch and simple epicyclic gear; and

FIG. 3 a modified interaxle differential as shown in FIG. 1 with double epicyclic gear.

In FIG. 1 10 designates the drive mechanism for an all-wheel drive for vehicles, with a speed change gear 12 (only part of which is shown) having an integrated axle differential 14 for driving the front wheels of the vehicle, an interaxle differential 16, also integrated (see detail in FIGS. 2 or 3), and a driven shaft 18 (such as a cardan shaft) which is drive-connected to an axle differential 19 which is drive-connected to the rear wheels of the vehicle.

The drive flow proceeds from a driving power output shaft 20 by way of a separating coupler 22 to the drive input shaft 24 and by way of speed stages 26 or 28 (shown only in part) to a hollow drive shaft 30.

The drive shaft 30 drives the interaxle differential 16 in a manner yet to be described, while the driven shafts 18, 40 drive the axle differentials 14, 19 by way of appropriate driving pinions 42 and ring gears 44.

The axle differentials 14 and 19, which are bevel differential gears, have different transmission ratios (such as ring gears 44 with different numbers of gear teeth), the transmission ratio of the rear axle differential 19 being designed to be lower than that of the front axle differential 14. That is, in non-slip break away of the front wheels and rear wheels of the vehicle (not shown) the driven shaft rotates relatively faster than does the driven shaft driving the front axle differential 40.

FIG. 2 shows that the interaxle differential 16 is configured as a simple epicyclic gear with a planet carrier 32 as drive element which is drive-connected by way of the planet wheels 34 to the externally toothed sun wheel 36 and the internally toothed external gear 38.

In this configuration the sun wheel 36 as one driven element is mounted on the output shaft 40 and drives the front axle differential 14 in drag through the hollow drive shaft 30, while the driven shaft 18 is connected to the other output element of the epicyclic gear or the external gear 38.

The configuration of the interaxle differential 16 or its planet wheel is such that in the basic distribution a higher output torque (70%) is output onto the driven shaft 18 to the axle differential 19 to the shorter drive transmission and a lower output torque (30%) is output onto the output shaft 40 to the front axle differential 14.

In addition, there is integrated into the interaxle differential 16 a disk clutch shown only in simplified form whose housing 48 is rigidly connected to the planet wheel carrier 32 and whose disks 50 are non-rotationally connected by conventional means to the output shaft 40 with the lower output torque by conventional means, by way of wedge gearing (not shown).

The disk clutch 46 is operated by conventional means (not shown) so as to be electrohydraulically (or electrically) slip-controlled and effects continuously variable change in the assigned output torque distribution of the interaxle differential 16.

When the disk clutch 46 has been fully opened it exerts no effect and the output torque of the interaxle differential 16, as has been indicated, is by priority applied to the rear wheels of the vehicle. The rotational speed difference of the two output shafts 18, 40 is adjusted in the interaxle differential 16 by way of the planet wheels 34.

If the output torque distribution of the interaxle differential 16 is to be continuously varied on the basis of specific operation parameters of the vehicle yet to be described from the rear-load basic distribution of 70:30, for example, to neutral (50:50) or to front-load distribution (such as 30:70), the disk clutch 46 is increasingly closed (but always in the slip range), as a result of which the output torque is increasingly displaced from the driven shaft 18 to the driven shaft 40 on the basis of the rotational speed difference which is present.

Slip control of the disk clutch 46 is effected by way of an electronic control mechanism (not shown) which controls clutch slip for variable modification of the output torque value of the interaxle differential 16 as a function of operating or vehicle movement parameters, the control mechanism actuating an appropriate hydraulic actuating mechanism having a source of pressure medium and an operating cylinder.

The control mechanism evaluates, among other things, both signals from a driving program selection switch of a control mechanism of the speed change gear 12 and signals from a control mechanism of a vehicle movement stability program of the vehicle, in such a way that, when a sports car program of the optionally automatic speed change gear 12 is introduced, a higher rear-load condition of the all-wheel drive (less slip engagement of the disk clutch 46) being accordingly assumed than in the event of a winter program with more cautious driving, with more neutral torque distribution.

In addition to brake engagement and/or drive torque reduction in the internal combustion engine, the driving stability program or its control mechanism may engage the slip control of the disk clutch 46 and, when instability of the vehicle begins (recognizable, for example, by way of a yaw angle sensor of the driving stability program), the output torque distribution of the interaxle differential 16 is quickly and effectively changed in the direction of neutral.

The same also applies to roadway conditions, driving speed, braking and/or acceleration conditions, etc. of the vehicle.

In the case of the interaxle differential 16′ shown in FIG. 3 a double epicyclic gear is used as indicated in the following rather than the simple epicyclic gear. The same parts are identified by the same reference numbers.

In this instance the driven shaft 18 for driving the rear axle differential 19 is drive-connected to the planet carrier 52 as one output element of the epicyclic gear.

The housing 48 of the disk clutch 46 also carries the external wheel 54 as drive element of the double epicyclic gear.

The other output element is the sun wheel 56, which, as before, is connected to the front axle differential 14 and the clutch disks 50 by way of the output shaft 40.

The sun wheel 52 carries on appropriate pivot pins planet wheels 58 which are radially displaced from each other and mesh with each other; the radially inner planet wheels 58 mesh with the sun wheel 56 and the radially outer planet wheels 58 with the external wheel 54.

This permits greater differentiation by conventional means of output torque distribution of the interaxle differential 16′ and an adjustment range, thereby considerably expanded, of the variable output. The operation of the interaxle differential 16′ is in other respects as described in the foregoing.

The invention is not limited to the exemplary embodiments described. Thus, the various drive ratios of the axle differentials 14, 19 may also be established by means of additional gears (a reduction gear, for example) or even by different tire sizes on the front wheels and rear wheels of the vehicle. The slip control of the disk clutch 46 may also be used as differential lock, but a residual slip on the disk clutch must always be ensured.

1. A drive mechanism for all-wheel-drive vehicles comprising:
a change-speed gear and an interaxle differential for output torque distribution to a first and a second axle differential by way of which the front wheels and the rear wheels of the vehicle are driven,
a drive shaft of the change-speed gear driving a drive element of the interaxle differential and output elements being drive-connected to the axle differentials and a clutch affecting the output torque distribution being provided,
wherein:
the output transmission ratios between the first and the second axle differential are different;
the interaxle differential is configured such that the output torque to the two axle differentials is different, the higher output torque being applied to the shorter transmission axial differential;
a slip-controlled disk clutch is introduced between the drive element of the interaxle differential and the output element with the lower output torque; and
the disk clutch is controllable as a function of the operation parameters of the vehicle for variable distribution of the output torque values of the interaxle differential.

2. The mechanism as claimed in claim 1, wherein the shorter output transmission is effected at the axle differential driving the rear wheels of the vehicle and wherein the higher output torque of the interaxle differential is switched to this axle differential (19).

3. The mechanism as claimed in claim 1, wherein the interaxle differential is an epicyclic gear.

4. The mechanism as claimed in claim 1, wherein the drive shaft of the speed change gear connected to the drive element is a hollow shaft on the end of which facing the drive element the disk clutch is mounted which may be coupled by the drive shaft to the output shaft of the interaxle differential.

5. The mechanism as claimed in claim 1, wherein the drive element of the planet wheel is the planet wheel carrier and wherein the output elements are in the form of the sun wheel and the external gear.

6. The mechanism as claimed in claim 1, wherein the external gear of the planet wheel with the higher output torque is drive-connected to the shorter transmission axle differential for driving the rear wheels of the vehicle.

7. The mechanism as claimed in claim 1, wherein the epicyclic gear is a double epicyclic gear the radially inner planet wheels of which mesh with the sun wheel and the radially outer planet wheels of which mesh with the external gear, wherein, in addition, the external gear forms the drive element, and wherein the output element is the sun wheel with respect to the axle differential with shorter transmission.

8. The mechanism as claimed in claim 1, wherein the slip-controlled disk clutch is controlled as a function of operation parameters and/or parameters of the operating dynamics of the vehicle in such a way that the output torque of the interaxle differential may be adjusted continuously from the structurally determined output torque distribution with priority at one axle differential by way of a neutral distribution to an output torque distribution with priority at the other axle differential.

9. The mechanism as claimed in claim 1, wherein the operation parameters are a plurality of electronically recorded driving programs of an automatic speed change gear of the vehicle in the preselection of which different output torque distributions of the interaxle differential are determined by appropriate actuation of the disk clutch.

10. The mechanism as claimed in claim 1, wherein the driving dynamics parameters are stored in a control unit of an electronic driving stability program of the vehicle and wherein, in addition to the conventional engagement operations such as brake engagement and reduction of the drive torque of the driving machine, the output torque distribution of the interaxle differential is changed in the direction of neutral and optionally beyond by means of appropriate additional actuation of the disk clutch.
